(19) United States
(12) Patent Application Publication
(10) Pub. No.: US 2016/0304055 A1
(43) Pub. Date: Oct. 20, 2016

(54) SMART KEY SECURITY SYSTEM FOR A VEHICLE AND A METHOD OF ALERTING A VEHICLE SECURITY CONCERN

(71) Applicant: GM GLOBAL TECHNOLOGY OPERATIONS LLC, Detroit, MI (US)

(72) Inventor: Dhyaneshwar Murugesan, Warren, MI (US)

(73) Assignee: GM GLOBAL TECHNOLOGY OPERATIONS LLC, Detroit, MI (US)

(21) Appl. No.: 14/686,075

(22) Filed: Apr. 14, 2015

(51) Int. Cl. B60R 25/24; B60Q 9/00

(52) U.S. Cl. CPC B60R 25/245; B60Q 9/00

(57) ABSTRACT

A method of securing a vehicle includes, signaling a control device, e.g., a key fob, to provide an alert to notify an operator of the vehicle when the control device is currently outside a pre-defined detection area, and either a window of the vehicle is currently disposed in a lowered position, or a door lock of the vehicle is currently disposed in an unlocked state. Upon the control device authenticating the signal, an alert component of the control device emits an alert signal, such as a visual alert, auditory alert, or tactile alert.

### TECHNICAL FIELD

The disclosure generally relates to a security system for a vehicle, and to a method of alerting an operator of the vehicle.

### BACKGROUND

Vehicles include several different types of security systems to prevent break-in and/or theft. The most common security features on a vehicle include windows that roll up to seal the interior of the vehicle, and door locks which lock the doors of the vehicle and prevent the doors from being opened unless unlocked. However, these security features only work if the windows are rolled completely up, and the door locks are engaged. Often, an operator of the vehicle will walk away from the vehicle and forget to engage these security systems, or is unable to remember if he/she engaged these security systems.

### SUMMARY

A method of securing a vehicle is provided. The method includes sensing a current position of a window of the vehicle with a window position sensor. The current position of the window is sensed to determine if the window is currently disposed in a fully raised position, or if the window is currently disposed in a lowered position. A current status of a door lock of the vehicle is sensed with a lock status sensor. The current status of the door lock is sensed to determine if the door lock is currently disposed in a locked state, or if the door lock is currently disposed in an unlocked state. A current location of a control device, relative to the vehicle, is sensed with a proximity sensor on the vehicle. The current location of the control device is sensed to determine if the control device is currently located within a pre-defined detection area, or if the control device is currently located outside the pre-defined detection area. When the control device is currently outside the pre-defined detection area, and either the window of the vehicle is currently disposed in the lowered position, or the door lock of the vehicle is currently disposed in the unlocked state, the control device is signaled to provide an alert to notify an operator of the vehicle.

A vehicle is also provided. The vehicle includes at least one door lock that is moveable between a locked state for locking a door of the vehicle relative to a body of the vehicle, and an unlocked state allowing movement of the door relative to the body. A lock status sensor is coupled to the door lock, and is operable to sense in which of the locked state and the unlocked state at least one door is currently disposed. At least one window is moveable between a raised position completely closing an opening, and a lowered position allowing access through the opening. A window position sensor is coupled to the at least one window, and is operable to sense in which of the raised position and the lowered position the at least one window is currently disposed. A vehicle security controller is in electronic communication with the lock status sensor and the window position sensor for receiving data from the lock status sensor and the window position sensor respectively. The vehicle security controller includes tangible, non-transitory memory on which is recorded computer-executable instructions, including a vehicle security algorithm. A processor is operable to execute the vehicle security algorithm. The vehicle security controller further includes a transmitter circuit operable to transmit an electronic radio signal. The vehicle further includes a control device that is wirelessly connected to the vehicle security controller. The control device may be moved to a remote location relative to the vehicle. The control device includes tangible, non-transitory memory on which is recorded computer-executable instructions, including a code authorization algorithm. A microprocessor is operable to execute the code authorization algorithm. The control device further includes a receiving circuit that is operable to receive an electronic radio signal from the transmitter circuit of the vehicle security controller, and an alert component operable to emit an alert signal. The vehicle security algorithm is operable to transmit a signal from the transmitter circuit to the receiving circuit of the control device, when the door lock is currently disposed in the unlocked state, or when the window is currently disposed in the lowered position. The microprocessor of the control device is operable to authenticate the transmitted signal from the transmitter circuit via the code authorization algorithm, and communicate an alert signal to a carrier of the control device with the alert component of the control device.

Accordingly, the vehicle security controller determines if the window is currently lowered, if the door lock is currently unlocked, and if the control device is outside the pre-defined detection area. When the control device is outside the detection area, and either the window is currently lowered or the door lock is unlocked, the vehicle security controller signals the control device to emit a signal to alert the carrier of the control device.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a vehicle.

FIG. 2 is a flowchart representing a method of securing the vehicle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

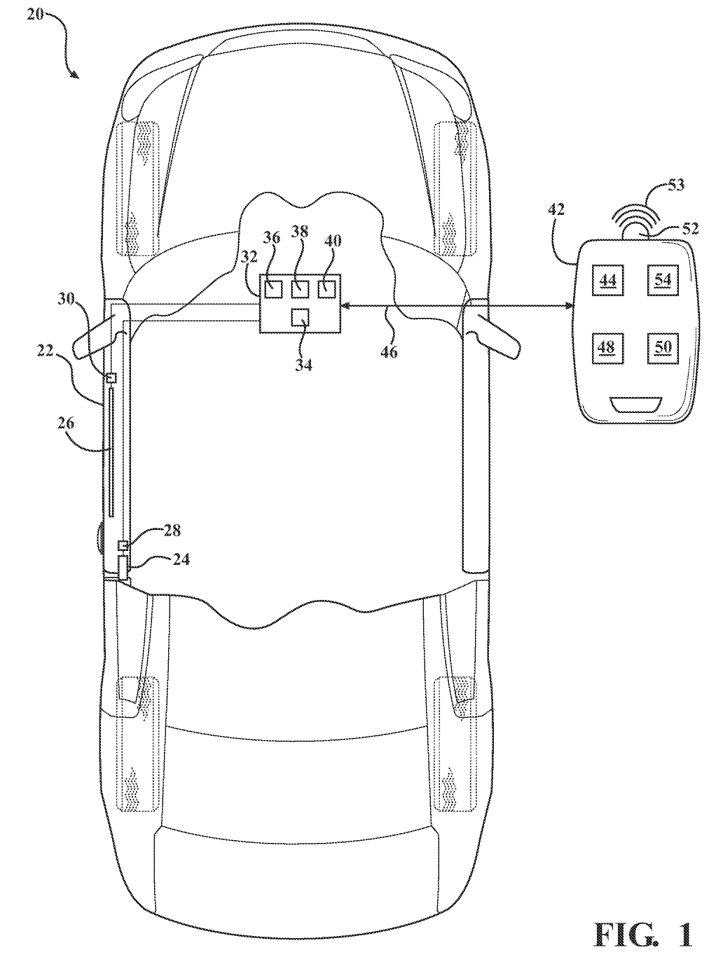

Referring to the Figures, wherein like numerals indicate like parts throughout the several views, a vehicle is generally shown at 20 in FIG. 1. Referring to FIG. 1, the vehicle 20 may include any type and/or style of vehicle 20 having at least one door 22 secured to a body of the vehicle 20 with a door lock 24. The vehicle 20 may further include at least one window 26 that is moveable between a raised position and a lowered position. For example, the vehicle 20 preferably includes a car, or truck. However, it should be appreciated that the vehicle 20 may include some other type and/or style of vehicle not specifically noted or described herein.

The door lock 24 is moveable between a locked state and an unlocked state. When disposed in the locked state, the door lock 24 is operable to lock or secure the door 22 of the vehicle 20 relative to the body of the vehicle 20. When the door lock 24 is disposed in the unlocked state, the door lock 24 allows movement of the door 22 relative to the body. The door lock 24 may operate in any manner suitable for and capable of securing the door 22 of the vehicle 20 relative to the body of the vehicle 20, as is known in the art. For example, the door lock 24 may prevent movement of a door 22 latch, thereby preventing the door 22 from being unlatched and opened. The configuration and operation of the door lock 24 is not pertinent to the description of the disclosure, and is therefore not described in detail herein.

The vehicle 20 includes a lock status sensor 28. The lock status sensor 28 is coupled to the door lock 24, and is operable to sense in which of the locked state and the unlocked state the door lock 24 is currently disposed. The lock status sensor 28 may include any sensor capable of sensing and/or determining the status of the door lock 24. For example, the lock status sensor 28 may include a switch used to actuate the door lock 24, i.e., a lock switch. The position of the lock switch may be used as an indicator to sense and/or otherwise determine the position of the door lock 24. It is contemplated that the lock status sensor 28 may include some other sensor or device, either specifically dedicated to sensing the state of the door lock 24, or used to sense some other data that may in turn be used to determine the status of the door lock 24.

As noted above, the window 26 is moveable between a raised position and a lowered position. Preferably, the window 26 is incorporated into and is part of the door 22 of the vehicle 20. However, the scope of the claims should not be limited to such an embodiment. When the window 26 is disposed in the raised position, the window 26 completely closes or seals an opening, thereby preventing access to an interior of the vehicle 20 through the opening. When the window 26 is disposed in the lowered position, the window 26 allows access into the interior of the vehicle 20 through the opening. As used herein, the lowered position should be appreciated to include any position of the window 26 other than the fully raised position that completely closes the opening.

The vehicle 20 includes a window position sensor 30. The window position sensor 30 is coupled to the window 26, and is operable to sense in which of the raised position and the lowered position the window 26 is currently disposed. The window position sensor 30 may include any sensor capable of sensing and/or determining the position of the window 26. For example, the window position sensor 30 may include a switch used to actuate the window 26, i.e., a window 26 switch. The position of the window 26 switch may be used as an indicator to sense and/or otherwise determine the position of the window 26. It is contemplated that the window position sensor 30 may include some other sensor or device, either specifically dedicated to sensing the position of the window 26, or used to sense some other data that may in turn be used to determine the position of the window 26.

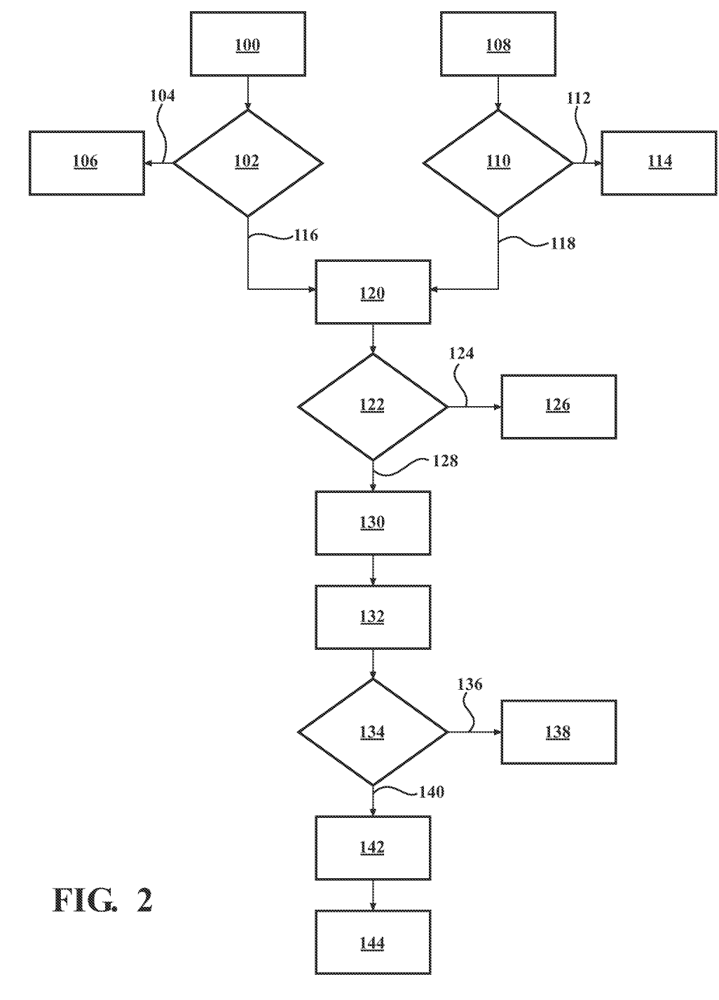

The vehicle 20 further includes a vehicle security controller 32. The vehicle security controller 32 is disposed in electronic communication with the lock status sensor 28, the window position sensor 30, and a proximity sensor 34 (described in greater detail below), for receiving data from the lock status sensor 28, the window position sensor 30, and the proximity sensor 34 respectively. The vehicle security controller 32 may include a computer and/or processor 36, and include all software, hardware, memory, algorithms, connections, sensors, etc., necessary to manage and control a security operation of the vehicle 20. As such, a method, described below and generally shown in FIG. 2, may be embodied as a program operable on the vehicle security controller 32. It should be appreciated that the vehicle security controller 32 may include any device capable of analyzing data from the various sensors, comparing the received data, making the necessary decisions required to execute the security operation, and executing the required tasks necessary to alert an operator of the vehicle 20, described in greater detail below.

The vehicle security controller 32 may be embodied as one or multiple digital computers or host machines each having one or more processors 36, read only memory 38 (ROM), random access memory 38 (RAM), electrically-programmable read only memory 38 (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 38 may include any non-transitory/tangible medium which participates in providing data or computer-readable instructions. Memory 38 may be non-volatile or volatile. Non-volatile media may include, for example, optical or magnetic disks and other persistent memory 38. Example volatile media may include dynamic random access memory 38 (DRAM), which may constitute a main memory 38. Other examples of embodiments for memory 38 include a floppy, flexible disk, or hard disk, magnetic tape or other magnetic medium, a CD-ROM, DVD, and/or any other optical medium, as well as other possible memory devices such as flash memory.

The tangible, non-transitory memory 38 includes computer-executable instructions recorded thereon, including, for example, a vehicle 20 security algorithm. The processor 36 of the controller is operable to execute the vehicle 20 security algorithm. The vehicle 20 security algorithm implements a method of alerting an operator of the vehicle 20 if the door lock 24s and/or window 26s are in an unsecured state or position.

The vehicle 20 controller further includes a transmitter circuit 40. The transmitter circuit 40 is operable to transmit an electronic radio signal. The transmitter circuit 40 may be configured in any suitable manner capable of transmitting a radio signal a short distance between the vehicle 20 and a control device 42, described in greater detail below. As noted above, the vehicle security controller 32 executes the vehicle 20 security algorithm. The vehicle 20 security algorithm is operable to determine the position of the window 26, the status of the door lock 24, and if the control device 42 is located within a pre-defined detection area 46 relative to the vehicle 20. Additionally, the vehicle 20 security algorithm is operable to transmit a signal from the transmitter circuit 40 to a receiving circuit 44 of the control device 42 when the control device 42 is located outside the pre-defined detection area 46 relative to the vehicle 20, and either the door lock 24 is currently disposed in the unlocked state, and/or the window 26 is currently disposed in the lowered position.

The control device 42 is wirelessly connected to the vehicle security controller 32. The control device 42 is moveable relative to the vehicle 20 to a remote location. Preferably, the control device 42 is a key fob commonly used to perform such functions as actuating the door lock 24 between the locked state and the unlocked state, activating or deactivating a vehicle 20 alarm system, de-latching or opening a rear hatch or trunk, or some other function of the vehicle 20 that may be performed from a location remote from the vehicle 20. However, it is contemplated that the control device 42 may alternatively include a handheld mobile communication device, such as a cellular phone or personal computing device that is electronically linked with the vehicle security controller 32.

As noted above, the vehicle 20 includes the proximity sensor 34 that is linked in electronic communication with the vehicle security controller 32. The proximity sensor 34 is operable to sense the location of the control device 42 relative to the vehicle 20 and/or the vehicle security controller 32. For example, the proximity sensor 34 may sense a distance that the control device 42 is from the vehicle 20. The vehicle security controller 32 may then use that sensed distance, and compare it to a pre-defined detection distance, to determine if the control device 42 is within the pre-defined detection area 46 of the vehicle 20, or if the security device is not within the pre-defined detection area 46 of the vehicle 20. The pre-defined detection area 46 of the vehicle 20 may include any distance or radius within the vehicle 20 suitable for indicating that the operator intends to leave the vehicle 20 for an extended period of time, and is not merely standing outside the vehicle 20 and remaining nearby. Alternatively, the proximity sensor 34 may be configured to only sense the presence of the control device 42 within a pre-defined area, i.e., the pre-defined detection area 46. If the proximity sensor 34 detects the control device 42, the vehicle security controller 32 may determine that the control device 42 is within the pre-defined detection area 46. If the proximity device does not detect the control device 42, then the vehicle security controller 32 may determine that the control device 42 is not within the pre-defined detection area 46. It should be appreciated that the proximity sensor 34 may communicate with the control device 42, and that the vehicle security controller 32 may use data from the proximity sensor 34 and/or the control device 42 to determine if the control device 42 is within the pre-defined detection area 46.

The control device 42 may include tangible, non-transitory memory 48 on which is recorded computer-executable instructions, such as for example a code authorization algorithm. The control device 42 may further include a microprocessor 50 that is operable to execute the code authorization algorithm. The code authorization algorithm compares a signal received from the vehicle security controller 32 to an embedded access code to verify or authenticate that the received signal is from the vehicle security controller 32 associated and/or linked to the control device 42, and is not a signal from some other vehicle 20 controller. As noted above, the control device 42 includes a receiving circuit 44. The receiving circuit 44 is disposed in electronic communication with the microprocessor 50 of the control device 42. The receiving circuit 44 is operable to receive the radio signal from the transmitter circuit 40 of the vehicle security controller 32, and communicate the received signal to the microprocessor 50 of the control device 42 so that the code authorization algorithm may compare it to the access code.

The control device 42 further includes an alert component 52. The alert component 52 is operable to emit an alert signal, when controlled to do so by the microprocessor 50 of the control device 42. The alert component 52 may include, for example, an audio alert component that is operable to generate an audio alert signal, a visual alert component that is operable to generate a visual signal, or a tactile alert component that is operable to generate a tactile signal, e.g., vibration. It should be appreciated that the alert component 52 may further include combinations of the above exemplary types of alert components, or some other form of an alert component. If the code authorization algorithm of the microprocessor 50 authenticates the received signal, the microprocessor 50 is operable to signal and/or control the alert component 52 to communicate an alert signal 53 to a carrier of the control device 42.

The control device 42 may also include a stop alert button 54 or switch that is disposed in communication with the microprocessor 50 of the control device 42. When actuated, e.g., pressed, the stop alert button 54 is operable to signal the microprocessor 50 to de-activate or turn off the alert signal 53.

A method of securing a vehicle 20 is also provided. As noted above, the method is implemented by the vehicle security controller 32 and the control device 42. Referring to FIG. 2, the method includes sensing a current position of the window 26 of the vehicle 20, generally indicated by box 100. The position of the window 26 is sensed with the window position sensor 30, and/or determined by the vehicle security controller 32. The position of the window 26 is sensed to determine if the window 26 is currently disposed in the fully raised position, or if the window 26 is currently disposed in the lowered position, generally indicated by box 102. If the window 26 is disposed in the fully raised position, generally indicated at 104, then the window 26 is secure, and no further action is required related to the security of the window 26, generally indicated by box 106.

Simultaneously with sensing the position of the window 26, the current status of the door lock 24 of the vehicle 20 is sensed, generally indicated by box 108. The status of the door lock 24 is sensed with the lock status sensor 28, and/or determined by the vehicle security controller 32. The status of the door lock 24 is sensed to determine if the door lock 24 is currently disposed in the locked state, or if the door lock 24 is currently disposed in the unlocked state, generally indicated by box 110. If the door lock 24 is disposed in the locked state, generally indicated at 112, then the door 22 is secure, and no further action is required related to the security of the door lock 24, generally indicated by box 114.

If either the window 26 is currently disposed in the lowered position, generally indicated at 116, and/or the door lock 24 is currently disposed in the locked state, generally indicated at 118, then the current location of a control device 42 relative to the vehicle 20 is sensed, generally indicated by box 120. The location of the control device 42 is sensed with the proximity sensor 34 and/or determined by the vehicle security controller 32. The location of the control device 42 is sensed to determine if the control device 42 is currently located within the pre-defined detection area 46, or if the control device 42 is currently located outside the pre-defined detection area 46, generally indicated by box 122.

If the control device 42 is currently located within the pre-defined detection area 46, generally indicated at 124, then the vehicle security controller 32 takes no action, generally indicated by box 126. However, if the control device 42 is currently not located within the pre-defined detection area 46, or as soon as the control device 42 moves outside the pre-defined detection area 46, generally indicated at 128, then the vehicle security controller 32 signals the control device 42 to provide an alert, generally indicated by box 130. Accordingly, when the control device 42 is currently outside the pre-defined detection area 46, and either the window 26 of the vehicle 20 is currently disposed in the lowered position, or the door lock 24 of the vehicle 20 is currently disposed in the unlocked state, then the vehicle security controller 32 signals the control device 42 to communicate an alert to a carrier of the control device 42. Preferably, the vehicle security controller 32 continuously monitors the position of the control device 42, such that as soon as the control device 42 moves outside the pre-defined detection area 46, the vehicle security controller 32 signals the control device 42 to communicate the alert signal 53. As described above, signaling the control device 42 may include emitting a signal with the transmitter circuit 40 of the vehicle security controller 32 to signal the control device 42 to provide the alert.

Upon the transmitter circuit 40 emitting the signal for the control device 42, the receiver circuit of the control device 42 receives the signal, generally indicated by box 132. the received signal is communicated to the microprocessor 50 by the receiver circuit, so that the code authorization algorithm may authenticate the signal from the transmitter circuit 40. The code authorization algorithm compares the received signal to the pre-defined code with the microprocessor 50 of the control device 42 to determine if the received signal is equal to the pre-defined code, or if the received signal is not equal to the pre-defined code, generally indicated by box 134.

If the code authorization algorithm determines that the received signal is not equal to the pre-defined access code, generally indicated at 136, then the received signal is not authenticated, and no action is taken, generally indicated by box 138. However, if the code authorization algorithm determines that the received signal is equal to the pre-defined access code, generally indicated at 140, then the microprocessor 50 of the control device 42 signals the alert component 52 to communicate the alert signal 53 to the carrier of the control device 42, generally indicated by box 142.

Communicating the alert signal 53 to the carrier of the control device 42 may include one of, but is not limited to, emitting a visual alert, emitting an auditory alert, or emitting a tactile alert. Additionally, because the alert may be the result of either the window 26 being in the lowered position, or the door lock 24 being in the unlocked state, communicating the alert signal 53 may include communicating a first alert sequence when the window 26 is currently disposed in the lowered position, communicating a second alert sequence when the door lock 24 is currently disposed in the unlocked state, and/or communicating a third alert sequence when both the window 26 is currently disposed in the lowered position and the door lock 24 is currently disposed in the unlocked state. Accordingly, the specific type and/or sequence of the alert signal 53 may vary to indicate what the security concern is, i.e., whether the window 26 is lowered or the door 22 is unlocked. The different alert signals 53 may be configured in any suitable manner, such as by length or sequence of signals, or with different types and/or combinations of alert signals 53.

Upon the carrier of the control device 42 recognizing the alert signal 53 emitted from the alert component 52 of the control device 42, the alert signal 53 may be de-activated, i.e., stopped, by pressing the stop alert button 54 on the control device 42, generally indicated by box 144.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of securing a vehicle, the method comprising:
sensing a current position of a window of the vehicle with a window position sensor to determine if the window is currently disposed in a fully raised position, or if the window is currently disposed in a lowered position;
sensing a current status of a door lock of the vehicle with a lock status sensor to determine if the door lock is currently disposed in a locked state, or if the door lock is currently disposed in an unlocked state;
sensing a current location of a control device relative to the vehicle with a proximity sensor on the vehicle, to determine if the control device is currently located within a pre-defined detection area, or if the control device is currently located outside the pre-defined detection area; and
signaling the control device to provide an alert when the control device is currently outside the pre-defined detection area, and either the window of the vehicle is currently disposed in the lowered position, or the door lock of the vehicle is currently disposed in the unlocked state.

2. The method set forth in claim 1 wherein the window position sensor, the lock status sensor, and the proximity sensor are in electronic communication with a vehicle security controller of the vehicle, wherein the vehicle security controller includes a transmitter circuit operable to send a signal to the control device, and wherein signaling the control device is further defined as emitting a signal with the transmitter circuit of the vehicle security controller to signal the control device to provide the alert.

3. The method set forth in claim 2 wherein the control device includes a microprocessor having a receiver circuit, and wherein the method includes receiving the signal with the receiver circuit of the control device.

4. The method set forth in claim 3 further comprising comparing the received signal to a pre-defined code with the microprocessor of the control device to determine if the received signal is equal to the pre-defined code, or if the received signal is not equal to the pre-defined code.

5. The method set forth in claim 4 further comprising communicating an alert to a carrier of the control device with an alert component of the control device, when the received signal is equal to the pre-defined code.

6. The method set forth in claim 5 wherein communicating the alert to the carrier of the control device includes one of emitting a visual alert, emitting an auditory alert, or emitting a vibratory alert.

7. The method set forth in claim 6 wherein communicating the alert to the carrier of the control device includes communicating a first alert sequence when the window is currently disposed in the lowered position, and communicating a second alert sequence when the door lock is currently disposed in the unlocked state.

8. The method set forth in claim 7 wherein communicating the alert to the carrier of the control device includes communicating a third alert sequence when both the window is currently disposed in the lowered position and the door lock is currently disposed in the unlocked state.

9. The method set forth in claim 5 further comprising de-activating the alert from the control device by actuating a stop alert button on the control device.

10. The method set forth in claim 1 wherein the control device includes one of a key fob or a handheld mobile communication device.

11. A method of securing a vehicle, the method comprising:
sensing a current position of a window of the vehicle to determine if the window is currently disposed in a fully raised position, or if the window is currently disposed in a lowered position;
sensing a current status of a door lock of the vehicle to determine if the door lock is currently disposed in a locked state, or if the door lock is currently disposed in an unlocked state;
sensing a current location of a control device relative to the vehicle, to determine if the control device is currently located within a pre-defined detection area, or if the control device is currently located outside the pre-defined detection area;
signaling the control device with a transmitter circuit of a vehicle security controller to provide an alert to a carrier of the control device when the control device is currently outside the pre-defined detection area, and either the window of the vehicle is currently disposed in the lowered position, or the door lock of the vehicle is currently disposed in the unlocked state; and
communicating an alert signal to the carrier of the control device with an alert component of the control device upon the control device authenticating the signal from vehicle security controller.

12. The method set forth in claim 11 wherein communicating the alert signal with the alert component of the control device includes communicating one of an audio alert, a visual alert, or a tactile alert.

13. The method set forth in claim 12 wherein communicating the alert signal with the alert component of the control device includes communicating a first alert sequence when the window is currently disposed in the lowered position, and communicating a second alert sequence when the door lock is currently disposed in the unlocked state

14. A vehicle comprising:
at least one door lock moveable between a locked state for locking a door of the vehicle relative to a body of the vehicle, and an unlocked state allowing movement of the door relative to the body;
a lock status sensor coupled to the door lock and operable to sense in which of the locked state and the unlocked state the at least one door lock is currently disposed;
at least one window moveable between a raised position completely closing an opening, and a lowered position allowing access through the opening;
a window position sensor coupled to the at least one window and operable to sense in which of the raised position and the lowered position the at least one window is currently disposed;
a vehicle security controller in electronic communication with the lock status sensor and the window position sensor for receiving data from the lock status sensor and the window position sensor, and including:
tangible, non-transitory memory on which is recorded computer-executable instructions, including a vehicle security algorithm;
a processor operable to execute the vehicle security algorithm; and
a transmitter circuit operable to transmit an electronic radio signal;
a control device wirelessly connected to the vehicle security controller and moveable to a remote location, wherein the control device includes:
tangible, non-transitory memory on which is recorded computer-executable instructions, including a code authorization algorithm;
a microprocessor operable to execute the code authorization algorithm;
a receiving circuit operable to receive an electronic radio signal from the transmitter circuit of the vehicle security controller; and
an alert component operable to emit an alert signal;
wherein the vehicle security algorithm is operable to transmit a signal from the transmitter circuit to the receiving circuit of the control device when the at least one door lock is currently disposed in the unlocked state, or when the at least one window is currently disposed in the lowered position; and
wherein the microprocessor of the control device is operable to authenticate the transmitted signal from the transmitter circuit via the code authorization algorithm, and communicate an alert signal to a carrier of the control device with the alert component of the control device.

15. The vehicle set forth in claim 14 wherein the alert component is one of an audio alert component operable to generate an audio alert signal, a visual alert component operable to generate a visual signal, or a vibratory alert component operable to generate a tactile signal.

16. The vehicle set forth in claim 14 wherein the vehicle security controller includes a proximity sensor operable to sense a remote location of the control device relative to the vehicle security controller.

17. The vehicle set forth in claim 16 wherein the vehicle security algorithm is operable to determine if the control device is located within a pre-defined detection area relative to the vehicle, or if the control device is located outside the pre-defined detection area relative to the vehicle.

18. The vehicle set forth in claim 17 wherein the vehicle security algorithm is operable to transmit the signal from the transmitter circuit to the receiving circuit of the control device only when the control device is located outside the pre-defined detection area relative to the vehicle.

19. The vehicle set forth in claim 14 wherein the control device is a key fob.

20. The vehicle set forth in claim 14 wherein the control device includes a stop alert button in communication with the microprocessor of the control device, wherein the stop alert button is operable to signal the microprocessor to de-activate the alert signal when depressed.
